(19) United States
(12) Patent Application Publication
(10) Pub. No.: US 2010/0289756 A1
(43) Pub. Date: Nov. 18, 2010

(54) ACCELEROMETER-BASED CONTROL FOR RADIO BROADCAST RECEIVERS

(76) Inventors: Freddy A. Anzures, San Francisco, CA (US); Henry Mason, Santa Clara, CA (US); Lucas Newman, San Francisco, CA (US)

Correspondence Address: FISH & RICHARDSON P.C., PO BOX 1022, MINNEAPOLIS, MN, 55440-1022, US

(21) Appl. No.: 12/467,179

(22) Filed: May 15, 2009

(51) Int. Cl. G09G 5/00; G06F 3/041

(52) U.S. Cl. 345/173; 345/156

(57) ABSTRACT

Methods for controlling a radio broadcast receiver on a mobile device are disclosed. A user can switch the user interface for a radio broadcast receiver on a mobile device by rotating the mobile device from a first orientation to a second orientation. A user can control a radio broadcast receiver by creating some movement of a mobile device in a certain manner, such as shaking or tapping the mobile device. Movements of the mobile device are detected by an accelerometer in the mobile device and interpreted according to a set of predetermined and context-based rules. The context information can be provided by previous user inputs, other sensors in the mobile device, or the current state of the radio broadcast receiver or mobile device.

### BACKGROUND

The subject matter of this specification is related generally to controlling radio broadcast receivers.

Radio broadcasting has a long history of providing entertainment and information to the public. Many people rely on their local radio stations for daily local news, traffic and weather information, as well as for music and entertainment. Many users also subscribe to satellite radio programming. Each radio station broadcasts its programs using a particular frequency or within a narrow frequency band dedicated to that station. A radio broadcast receiver is an electronic device that is designed to receive radio signals transmitted by radio broadcasting services. A radio broadcast receiver includes a tuner that can be adjusted to selectively pick up a certain radio frequency or band of frequencies on which a radio station broadcasts its programs. The radio broadcast receiver typically also includes processing capabilities to convert the received radio signals into audio signals.

Many mobile devices today include hardware and software components that provide communication and entertainment functions to users. A user can provide input to operate a mobile device and/or software applications running on the mobile device through various hardware and software user interfaces. The design of the user interfaces and the type of user inputs that can be received and interpreted by a mobile device greatly affect user experience and hence the utility of the mobile device.

### SUMMARY

Methods for controlling a radio broadcast receiver on a mobile device are disclosed.

In one aspect, a computer-implemented method for controlling a radio broadcast receiver on a mobile device is disclosed. A first user interface for operating the radio broadcast receiver is presented on a display of the mobile device, the first user interface conforming to a first style. While the first user interface is presented on the display, a movement pattern of the mobile device is detected. In response to the detected movement pattern, a second user interface for operating the radio broadcast receiver is presented on the display in place of the first user interface, the second user interface conforming to a second style.

In some implementations, the detected movement pattern includes a rotation of the mobile device from a first orientation to a second orientation. In some implementations, the display is responsive to multi-touch gestures. The first user interface is responsive to a first multi-touch gesture for a particular control function of the radio broadcast receiver, and the second user interface is responsive to a second, different multi-touch gesture for the particular control function. In some implementations, for tuning to an adjacent radio station, the first multi-touch gesture is a single touch on a user interface element that indicates a tuning direction, and the second, different multi-touch gesture is a single flick across the display in the tuning direction.

In some implementations, the display is responsive to multi-touch gestures and the second user interface includes user interface elements each representing a respective radio broadcast frequency of a corresponding radio station. While the second interface is presented on the display, a user input directed toward one of the user interface elements is received. An expanded view of the user interface element is presented on the display. The expanded view represents a broadcast frequency band around the respective broadcast frequency of the user interface element. A multi-touch gesture is received for fine-tuning the radio broadcast receiver within the expanded view.

In one aspect, a computer-implemented method for controlling a radio broadcast receiver on a mobile device is disclosed. A movement pattern of the mobile device is detected. The movement pattern is associated with a control function of the radio broadcast receiver according to a predetermined set of rules. The control function is performed according to the movement pattern.

In some implementations, to detect the movement pattern, input detected by a motion sensor of the mobile device is received. The input is indicative of one or more of linear and rotational motions of the mobile device. A movement type and one or more movement parameters are determined based on the detected input. In some implementations, the determined movement type is a shaking movement of the mobile device. In some implementations, the determined movement type is associated with a shuffle control function of the radio broadcast receiver. The radio broadcast receiver is tuned from a currently selected radio broadcast frequency to a different radio broadcast frequency. In some implementations, the currently selected radio broadcast frequency is for a first radio station of a first genre, and the different radio broadcast frequency is for a second radio station of a second, different genre. In some implementations, the currently selected radio broadcast frequency and the different radio broadcast frequency are for radio stations of a same genre.

In some implementations, the different radio broadcast frequency is selected from a set of preset frequencies. In some implementations, the determined movement type is an impact of the mobile device against an object external to the mobile device. In some implementations, the movement pattern is associated with a sound control function of the radio broadcast receiver. In some implementations, the radio broadcast receiver is muted if the radio broadcast receiver was un-muted prior to detection of the movement pattern. In some implementations, the radio broadcast receiver is un-muted if the radio broadcast receiver was muted prior to detection of the movement pattern.

In an aspect, a computer-implemented method for controlling a radio broadcast receiver on a mobile device is disclosed. A shaking movement of the mobile device is detected. The shaking movement is associated with a shuffle function of the radio broadcast receiver. A currently selected broadcast frequency of the radio broadcast receiver is changed to a different broadcast frequency according to a random selection procedure.

Other embodiments of the disclosed aspects of the subject matter in this specification include corresponding systems, apparatus, devices, computer program products, and computer-readable media.

Particular embodiments of the subject matter described in this specification can be implemented to realize one or more of the following advantages.

In some implementations, a user can switch the user interface for a radio broadcast receiver on a mobile device by rotating the mobile device from a first orientation to a second orientation. The different user interfaces are operable to receive different types of user inputs for the same control functions of the radio broadcast receiver, such as shuffling, tuning, and so on. Rotating the mobile device is a simple and intuitive manipulation of the mobile device. This interface-switching mechanism is advantageous when a user wishes to employ one type of user input to control the radio broadcast receiver over another under different operating environments.

In some implementations, a user can control a radio broadcast receiver by creating some movement of a mobile device in a certain manner, such as shaking or tapping the mobile device. The user does not have to carefully and meticulously manipulate user interface elements laid out on a graphical user interface using his/her fingertips or a stylus in order to achieve a desired radio control function. Since no precise manipulation of the graphical user interface elements is required, a user can control the radio broadcast receiver while keeping his/her attention focused on some other tasks, such as driving, jogging, and so on. Direct physical movement of the mobile device itself provides a more direct and intuitive way to control the radio broadcast receiver.

In some implementations, movements of the mobile device are detected by a motion sensor (e.g., an accelerometer, gyro) in the mobile device and interpreted according to a set of predetermined and context-based rules. The context information can be provided by previous user inputs, other sensors in the mobile device, the current state of the radio broadcast receiver, or the current state of the mobile device. By using a wide variety of context information, only a few simple and intuitive movement patterns are required to operate the radio broadcast receiver, and the interpretation of each movement pattern becomes more accurate given the context of the movement.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example mobile device.

FIG. 2 is a block diagram of an example implementation of the mobile device of FIG. 1.

FIGS. 3A-3B are example graphical user interfaces for controlling a radio broadcast receiver.

FIGS. 4A-4B illustrate invocation of an example user interface for fine-tuning the radio broadcast receiver shown in FIGS. 3A-3B.

FIG. 5A illustrates an example process for presenting alternative user interfaces for controlling a radio broadcast receiver.

FIG. 5B illustrates an example process for presenting a user interface for fine-tuning a radio broadcast receiver.

FIGS. 6A-6B illustrate example processes for controlling a radio broadcast receiver in a mobile device based on a movement pattern of the mobile device.

FIGS. 7A-7C illustrate example processes for controlling a radio broadcast receiver using a shaking movement of the mobile device.

FIG. 8 illustrates an example process for controlling a sound function of the radio broadcast receiver based on an impact of the mobile device against another object.

Like reference numbers and designations in the various drawings indicate like elements.

### DETAILED DESCRIPTION

### Example Mobile Device

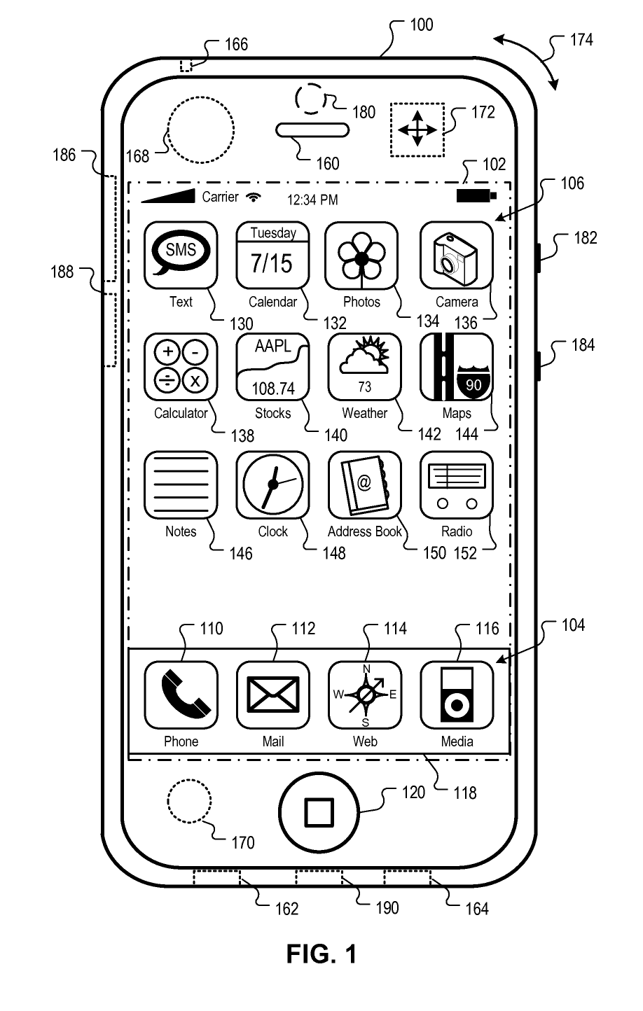

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 100 includes a touch-sensitive display 102. The touch-sensitive display 102 can implement liquid crystal display (LCD) technology, light emitting polymer display (LPD) technology, or some other display technology. The touch sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 100 can display one or more graphical user interfaces on the touch-sensitive display 102 for providing the user access to various system objects and for conveying information to the user. In some implementations, the graphical user interface can include one or more display objects 104, 106. In the example shown, the display objects 104, 106, are graphic representations of system objects. Some examples of system objects include device functions, applications, windows, files, alerts, events, or other identifiable system objects.

### Example Mobile Device Functionality

In some implementations, the mobile device 100 can implement multiple device functionalities, such as a telephony device, as indicated by a phone object 110; an e-mail device, as indicated by the e-mail object 112; a network data communication device, as indicated by the Web object 114; a Wi-Fi base station device (not shown); and a media processing device, as indicated by the media player object 116. In some implementations, particular display objects 104, e.g., the phone object 110, the e-mail object 112, the Web object 114, and the media player object 116, can be displayed in a menu bar 118. In some implementations, device functionalities can be accessed from a top-level graphical user interface, such as the graphical user interface illustrated in FIG. 1. Touching one of the objects 110, 112, 114, or 116 can, for example, invoke corresponding functionality.

In some implementations, the mobile device 100 can implement network distribution functionality. For example, the functionality can enable the user to take the mobile device 100 and provide access to its associated network while traveling. In particular, the mobile device 100 can extend Internet access (e.g., Wi-Fi) to other wireless devices in the vicinity. For example, mobile device 100 can be configured as a base station for one or more devices. As such, mobile device 100 can grant or deny network access to other wireless devices.

In some implementations, upon invocation of device functionality, the graphical user interface of the mobile device 100 changes, or is augmented or replaced with another user interface or user interface elements, to facilitate user access to particular functions associated with the corresponding device functionality. For example, in response to a user touching the phone object 110, the graphical user interface of the touch-sensitive display 102 may present display objects related to various phone functions; likewise, touching of the email object 112 may cause the graphical user interface to present display objects related to various e-mail functions; touching the Web object 114 may cause the graphical user interface to present display objects related to various Web-surfing functions; and touching the media player object 116 may cause the graphical user interface to present display objects related to various media processing functions.

In some implementations, the top-level graphical user interface environment or state shown in FIG. 1 can be restored by pressing a button 120 located near the bottom of the mobile device 100. In some implementations, each corresponding device functionality may have corresponding “home” display objects displayed on the touch-sensitive display 102, and the graphical user interface environment of FIG. 1 can be restored by pressing the “home” display object.

In some implementations, the top-level graphical user interface can include additional display objects 106, such as a short messaging service (SMS) object 130, a calendar object 132, a photos object 134, a camera object 136, a calculator object 138, a stocks object 140, a weather object 142, a maps object 144, a notes object 146, a clock object 148, an address book object 150, and a radio object 152. Touching the SMS display object 130 can, for example, invoke an SMS messaging environment and supporting functionality. Touching the radio object 152 can, for example, invoke a radio broadcast receiver environment and supporting functionality. Likewise, each selection of a display object 132, 134, 136, 138, 140, 142, 144, 146, 148, and 150 can invoke a corresponding object environment and functionality.

Additional and/or different display objects can also be displayed in the graphical user interface of FIG. 1. For example, if the device 100 is functioning as a base station for other devices, one or more “connection” objects may appear in the graphical user interface to indicate the connection. In some implementations, the display objects 106 can be configured by a user, e.g., a user may specify which display objects 106 are displayed, and/or may download additional applications or other software that provides other functionalities and corresponding display objects.

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, an up/down button 184 for volume control of the speaker 160 and the microphone 162 can be included. The mobile device 100 can also include an on/off button 182 for a ring indicator of incoming phone calls. In some implementations, a loud speaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Accordingly, display objects and/or media can be presented according to a detected orientation, e.g., portrait or landscape. In some implementations, the mobile device 100 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 100 or provided as a separate device that can be coupled to the mobile device 100 through an interface (e.g., port device 190) to provide access to location-based services.

In some implementations, a port device 190, e.g., a Universal Serial Bus (USB) port, or a docking port, or some other wired port connection, can be included. The port device 190 can, for example, be utilized to establish a wired connection to other computing devices, such as other communication devices 100, network access devices, a personal computer, a printer, a display screen, or other processing devices capable of receiving and/or transmitting data. In some implementations, the port device 190 allows the mobile device 100 to synchronize with a host device using one or more protocols, such as, for example, the TCP/IP, HTTP, UDP and any other known protocol.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

The mobile device 100 can also include a radio broadcast receiver (not shown). In some implementations, the radio broadcast receiver can receive and process radio signals transmitted from terrestrial and/or satellite sources. The radio broadcast signals can be Amplitude-Modulated (AM) signals or Frequency-Modulated (FM) signals, and can be analog signals or digital signals. In some implementations, the radio broadcast receiver can receive and decode simulcast, which includes additional information embedded in the radio broadcast signal stream, such as Radio Data System (RDS) metadata.

### Example Mobile Device Architecture

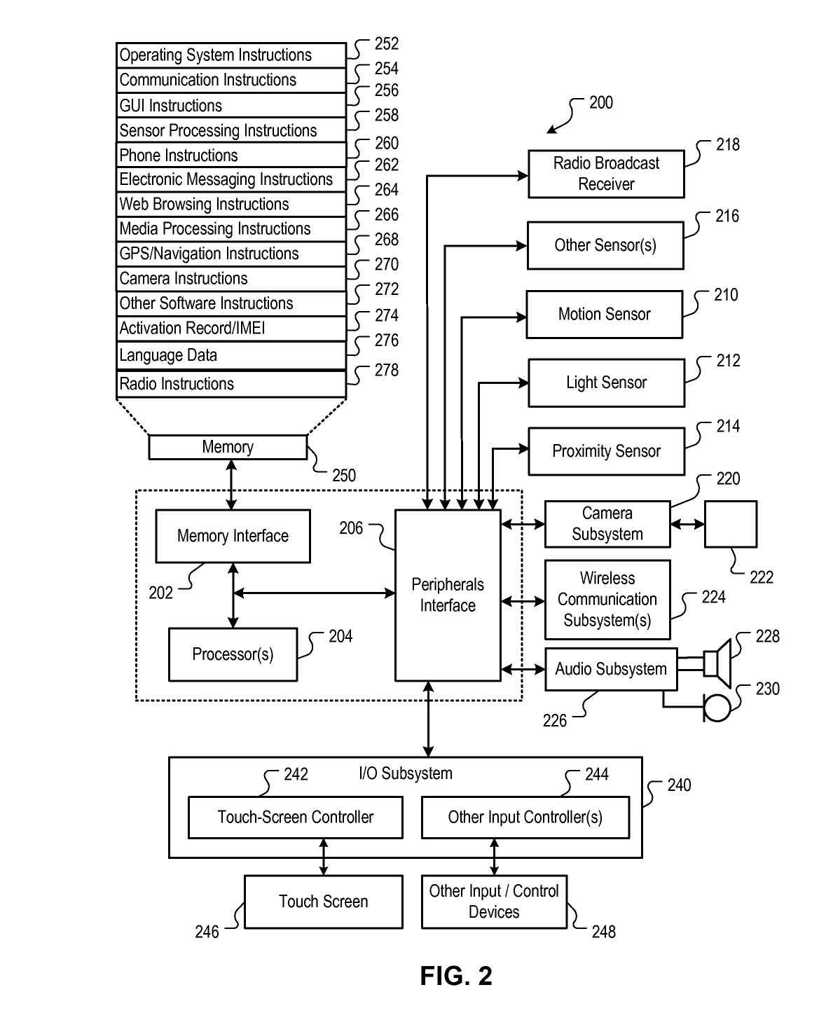

FIG. 2 is a block diagram 200 of an example implementation of the mobile device 100 of FIG. 1. The mobile device 100 can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device 100 can be coupled by one or more communication buses or signal lines.

Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions described with respect to FIG. 1. Other sensors 216 can also be connected to the peripherals interface 206, such as a positioning system (e.g., GPS receiver), a temperature sensor, a biometric sensor, or other sensing device, to facilitate related functionalities.

A radio broadcast receiver 218 can be coupled to the peripheral interface 206 to facilitate radio frequency broadcast reception and decoding functions. The radio frequency receiver 218 can be operable to receive AM and/or FM, digital and/or analog radio broadcast signals from terrestrial broadcast sources, relay stations, and/or satellite sources. In some implementations, the radio broadcast receiver 218 is operable to receive digital and/or analog radio broadcast signals. In some implementations, the radio broadcast receiver 218 is operable to receive simulcast signals. In some implementations, the radio broadcast receiver 218 includes a Radio Data System (RDS) processor which can process main broadcast content and content metadata. The radio broadcast receiver 218 is tunable to selectively receive broadcast signals on various frequencies or frequency bands/sub-bands.

A camera subsystem 220 and an optical sensor 222, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 224, which can include radio frequency receivers and transmitters and/or optical (e.g., infrared) receivers and transmitters. The specific design and implementation of the communication subsystem 224 can depend on the communication network(s) over which the mobile device 100 is intended to operate. For example, a mobile device 100 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 100 may be configured as a base station for other wireless devices.

An audio subsystem 226 can be coupled to a speaker 228 and a microphone 230 to facilitate voice-enabled functions, such as voice recognition, voice replication, digital recording, and telephony functions.

The I/O subsystem 240 can include a touch-screen controller 242 and/or other input controller(s) 244. The touch-screen controller 242 can be coupled to a touch screen 246. The touch screen 246 and touch-screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246.

The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230.

In one implementation, a pressing of the button for a first duration may disengage a lock of the touch screen 246; and a pressing of the button for a second duration that is longer than the first duration may turn power to the mobile device 100 on or off. The user may be able to customize a functionality of one or more of the buttons. The touch screen 246 can, for example, also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod™. The mobile device 100 may, therefore, include a 30-pin connector that is compatible with the iPod™. Other input/output and control devices can also be used.

The memory interface 202 can be coupled to memory 250. The memory 250 can include high-speed random access memory and/or non-volatile memory, such as one or more magnetic disk storage devices, one or more optical storage devices, and/or flash memory (e.g., NAND, NOR). The memory 250 can store an operating system 252, such as Darwin, RTXC, LINUX, UNIX, OS X, WINDOWS, or an embedded operating system such as VxWorks. The operating system 252 may include instructions for handling basic system services and for performing hardware dependent tasks. In some implementations, the operating system 252 can be a kernel (e.g., UNIX kernel).

The memory 250 may also store communication instructions 254 to facilitate communicating with one or more additional devices, one or more computers and/or one or more servers. The memory 250 may include graphical user interface instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GPS/Navigation instructions 268 to facilitate GPS and navigation-related processes and instructions; camera instructions 270 to facilitate camera-related processes and functions; and/or other software instructions 272 to facilitate other processes and functions, e.g., security processes and functions. The memory 250 may also store other software instructions (not shown), such as web video instructions to facilitate web video-related processes and functions; and/or web shopping instructions to facilitate web shopping-related processes and functions. In some implementations, the media processing instructions 266 are divided into audio processing instructions and video processing instructions to facilitate audio processing-related processes and functions and video processing-related processes and functions, respectively. An activation record and International Mobile Equipment Identity (IMEI) 274 or similar hardware identifier can also be stored in memory 250. In some implementations, memory 250 also includes language data 276. Language data 276 can include, for example, word dictionaries (i.e., list of possible words in a language) for one or more languages, dictionaries of characters and corresponding phonetics, one or more corpuses of characters and character compounds, and so on.

In some implementations, memory 250 also includes radio instructions 278. Radio instructions 278 can include instructions for processing of signals from the radio broadcast receiver 218, and user input from the I/O subsystem 340, as well as from various sensors, such as the motion sensor 210. Radio instructions 278 can also include instructions for operating the radio broadcast receiver 218 based on the input received from the I/O subsystem 340 and various sensors.

Each of the above identified instructions and applications can correspond to a set of instructions for performing one or more functions described above. These instructions need not be implemented as separate software programs, procedures, or modules. The memory 250 can include additional instructions or fewer instructions. Furthermore, various functions of the mobile device 100 may be implemented in hardware and/or in software, including in one or more signal processing and/or application specific integrated circuits.

### Controls for a Radio Broadcast Receiver

Mobile devices provide a significant communication and entertainment functions to users. By integrating a radio broadcast receiver into a mobile device, the utility of the mobile device is expanded.

A basic control of a radio broadcast receiver user interface is a tuning control. The tuning control adjusts a tuner of the radio broadcast receiver to traverse up or down a radio broadcast frequency range to selectively receive and amplify signals of each radio broadcast frequency within that frequency range. Because each radio station operates on a different discrete frequency or narrow frequency band (i.e., the station's respective radio broadcast frequency or frequency band), by adjusting the tuning control, a user can selectively tune in different radio stations.

In some implementations, a fine-tuning control is also included in the radio broadcast receiver user interface. For a radio station operating on a frequency band, signal strength and clarity of the radio station may vary slightly depending on various factors, such as the location and local environment of the mobile device. A user can adjust the fine-tuning control to traverse up or down the frequency band to achieve the best signal strength and clarity.

In some implementations, a user can store a number of preset stations (or preset broadcast frequencies) in the mobile device, and can select one of those preset stations on the user interface directly without scanning through a whole range of frequencies. The radio broadcast receiver can find and store preset stations by automatically scanning through the entire radio frequency range and pick out stations that have signal strengths that are above a predetermined threshold. Alternatively, a user can manually tune to a desired station, and enter the station into the preset. Sometimes, during the scanning, a radio receiver can pause for a brief moment at each detected radio broadcast frequency before moving onto the next frequency.

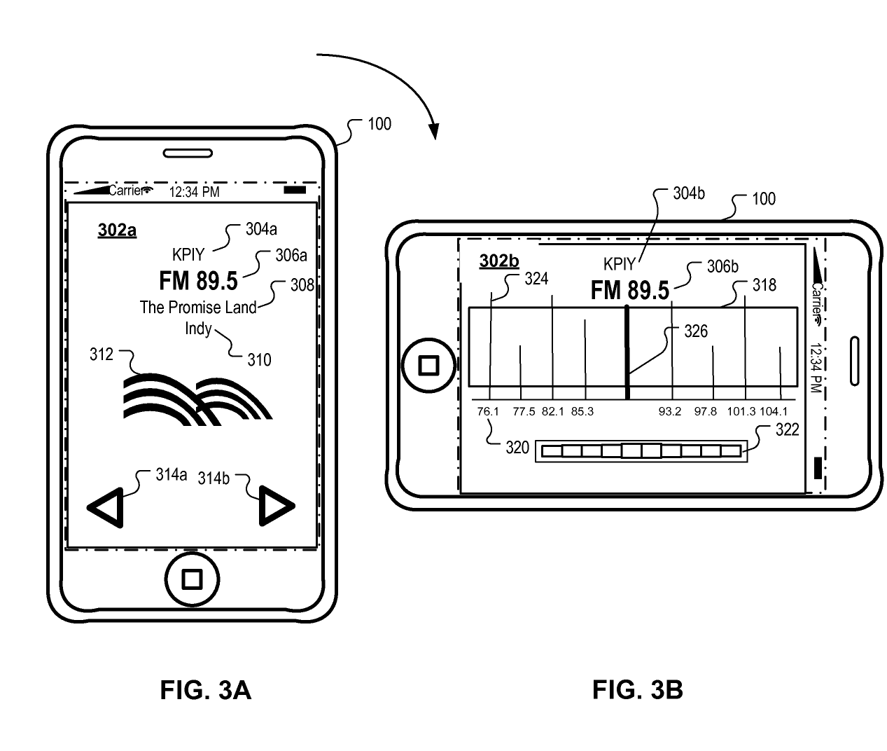

FIGS. 3A and 3B show two alternative example user interfaces for a radio broadcast receiver on a mobile device 100. The transition between the first user interface 302a in FIG. 3A and the second user interface 302b in FIG. 3B can be invoked by rotating the mobile device 100 from a first orientation (e.g., a portrait orientation) to a second orientation (e.g., a landscape orientation). The rotation of the mobile device 100 can be detected by a motion sensor in the mobile device 100. In some implementations, the rotation can be clockwise or counter-clockwise. In some implementations, clockwise and counter-clockwise rotations can invoke the same pair of alternative user interfaces or two different pairs of alternative user interfaces. In some implementations, the pair of alternative interfaces is of different styles from each other. A style of a user interface can include color schemes, textures, shapes, and sizes of the user interface elements included in the user interface. A style of the user interface also includes the defined function(s) of each user interface element as well as how the user interface element receives and responds to each type of user input.

In FIG. 3A, the example user interface 302a mimics the look and feel of a digital radio. The example user interface 302a includes a number of user interface elements, including a station name label 304a, a station frequency label 306a, RDS text data 308 (e.g., the name of the song, the artist, or the program that is being broadcast), a station genre label 310, and a station logo (or other related visual art) 312. The information displayed on the user interface 302a, such as the station name, the RDS text data, the station genre, and the station logo can be extracted from the radio broadcast signals if the radio station supports simulcast. In some implementations, visualization of signal strength for the selected station can also be included in the user interface (e.g., in the form of illuminated signal bars).

The user interface 302a further includes a pair of tuning controls 314a and 314b. One of the pair of tuning controls (314b) is for tuning up to a higher broadcast frequency, and the other (314a) is for tuning down to a lower broadcast frequency. In some implementations, a user can press the tuning control 314a (or 314b) with a single touch to jump to an adjacent radio station at a lower (or higher) broadcast frequency that has been stored in the presets. In some implementations, a user can press the tuning control 314a (or 314b) with a single touch to jump to an adjacent radio station at a lower (or higher) broadcast frequency that is of the same genre as the station that is currently selected. In some implementations, a continuous touch beyond predetermined threshold duration causes the radio broadcast receiver to quickly jump through multiple stations. In some implementations, a second pair of user interface elements for fine-tuning within a frequency band can be included in the user interface 302a. In some implementations, user elements for other controls of the radio broadcast receiver (e.g., for storing presets) can also be included in the user interface 302a.

In some implementations, the user interface elements included in the user interface 302a conform to a first style. For example, the user interface 302a has a style of a digital radio, and the user interface elements for the tuning control (314a and 314b) respond to single-touch directed toward the tuning control on the touch-sensitive display or surface to tune up or down the radio broadcast frequency range to a different station.

In FIG. 3B, the example user interface 302b mimics the look and feel of a traditional analog radio. The example user interface 302b includes a window 318 that shows a number of vertical bars (e.g., 324). Each of the vertical bars represents a detected radio station that has signal strength above a predetermined threshold. The broadcast frequency (e.g., 320) for each of these detected radio stations can be displayed below its respective vertical bar. In some implementations, the heights of the vertical bars represent signal strength. In some implementations, the vertical bars can be illuminated with different intensity to represent signal strength. The user interface 302b also includes a vertical marker 326. This vertical marker represents a currently selected tuning frequency of the radio broadcast receiver. In some implementations, when the broadcast frequency of a station matches the currently selected tuning frequency (e.g., the station's vertical bar overlaps with the vertical marker 326), the station becomes the currently selected station, and the station's broadcast frequency becomes the currently selected broadcast frequency. The user interface 302b can display the station name label 304b, and the broadcast frequency label 306b of the selected station.

In some implementations, the user interface 302b can optionally include a representation of a wheel 322 for tuning the radio broadcast receiver. A user can flick left or right across the multi-touch-sensitive display 302b over the area of the tuning wheel 322 for tuning up or down to a different broadcast frequency. In some implementations, the entire display is active for receiving multi-touch gestures from the user, and no tuning wheel needs to be presented. For example, a user can flick left or right across the window 318 to tune up or down to a different broadcast frequency. In some implementations, vertical marker 326 moves left or right in response to a user flicking across the multi-touch display in the left or right direction, while the vertical bars for the detected radio stations remain stationary within the window 318. In some implementations, the vertical bars displayed in the window 318 shift left or right in response to a user flicking across the multi-touch display in the left or right direction, while the vertical marker 326 remains stationary in the center of the window 318.

In some implementations, a user flicking across the multi-touch display causes the radio broadcast receiver to jump to an adjacent radio station that has been stored in the presets. In some implementations, a user flicking across the multi-touch display causes the radio broadcast receiver to jump to an adjacent radio station that is of the same genre as the currently selected station. In some implementations, multiple rapidly repeated flicking in the same direction causes the radio broadcast receiver to quickly scan through multiple broadcast frequencies. In some implementations, a single flick across the multi-touch display causes the radio broadcast receiver to continuously scan across the entire radio frequency range until a user touches the display to stop the scanning. In some implementations, a single flick across the multi-touch display causes the radio broadcast receiver to continuously scan through the entire radio frequency range, but slows down at (or pauses briefly over) each detected radio station. While the scanning slows down at each detected station, the station name label and the broadcast frequency label of the station can be magnified or otherwise embellished (e.g., flash, change color, etc.). In some implementations, the broadcast of each detected station is played for a short duration before the radio broadcast receiver proceeds to the next detected station. A user can stop the scanning at any time by a single touch or gesture on the multi-touch display.

In some implementations, the user interface elements included in the user interface 302b conform to a second style. For example, the user interface 302b has a style of an analog radio, and the user interface elements for the tuning control (314a and 314b) respond to a user flicking across the multi-touch display in a left or right direction to tune up or down a frequency range to a different station. The example user interface shown in FIG. 3B is illustrative. Other designs are possible. For example, a circular dial can be used to represent a tuning control. A user can flick up or down, clockwise or counter-clockwise to turn the circular dial.

In this example, a user can change the user interface for a radio broadcast receiver on a mobile device by rotating the mobile device from a first orientation to a second orientation. The different user interfaces are operable to receive different types of user inputs for the same control function of the radio broadcast receiver, such as tuning. Other suitable mappings between user interface elements, control functions, and types of user inputs can be implemented. Rotating the mobile device is a simple and intuitive manipulation of the mobile device. This interface-switching mechanism is advantageous when a user wishes to employ one type of user input to control the radio broadcast receiver over another under different operating environments.

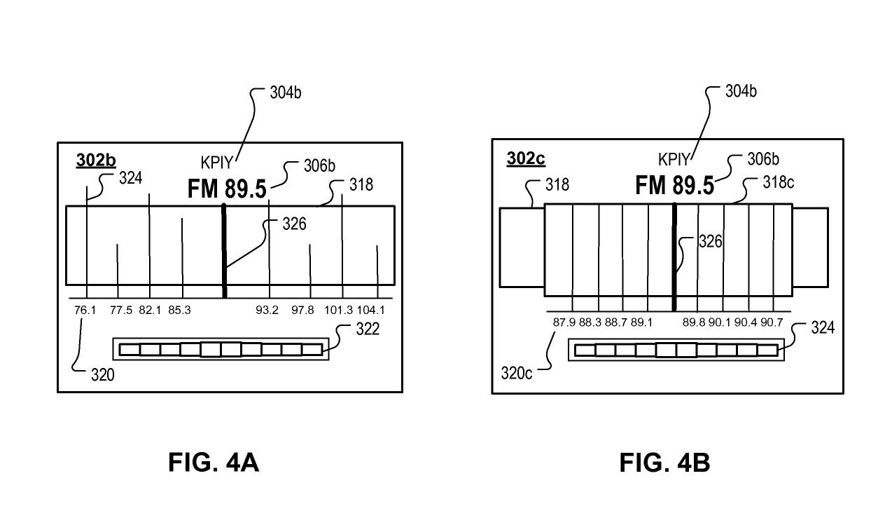

FIGS. 4A-4B illustrate the invocation of a fine-tuning control of the radio broadcast receiver from the example user interface shown in FIG. 3B.

FIG. 4A shows the same example user interface 302b as that shown in FIG. 3B. In this example, the currently selected broadcast frequency is FM 89.5, as shown by the broadcast frequency label 306b. The currently selected radio station is KPIY, as shown by the broadcast name label 304b. If the selected radio station broadcasts on a band of frequencies, a user can expand the vertical bar representing the broadcast frequency FM 89.5 to fine-tune the radio broadcast receiver around that broadcast frequency. The user interface 302c for fine-tuning can be invoked by a reverse-pinching gesture on the multi-touch display. For example, by moving two fingers in opposite directions across the multi-touch display, the narrow frequency band around the selected broadcast frequency is expand in a new window 318c, as shown in FIG. 4B. In some implementations, a single touch on the selected frequency range can also cause an expanded view of the narrow frequency band around the selected broadcast frequency to be presented. In some implementations, a single touch on any of vertical bars representing a detected radio broadcast frequency can cause that broadcast frequency to become the currently selected broadcast frequency, and also cause the narrow frequency band around the selected broadcast frequency to expand within the window 318c. A user can flick across the multi-touch display to scan up or down across the narrow frequency band in window 318c to find a frequency that provides the strongest and most clear signal reception. In some implementations, the speed of the flicking gesture can be used to determine how quickly the radio broadcast receiver scans across the narrow frequency band. In some implementations, flicking with two fingers at the same time can cause a slower scanning across the narrow frequency band.

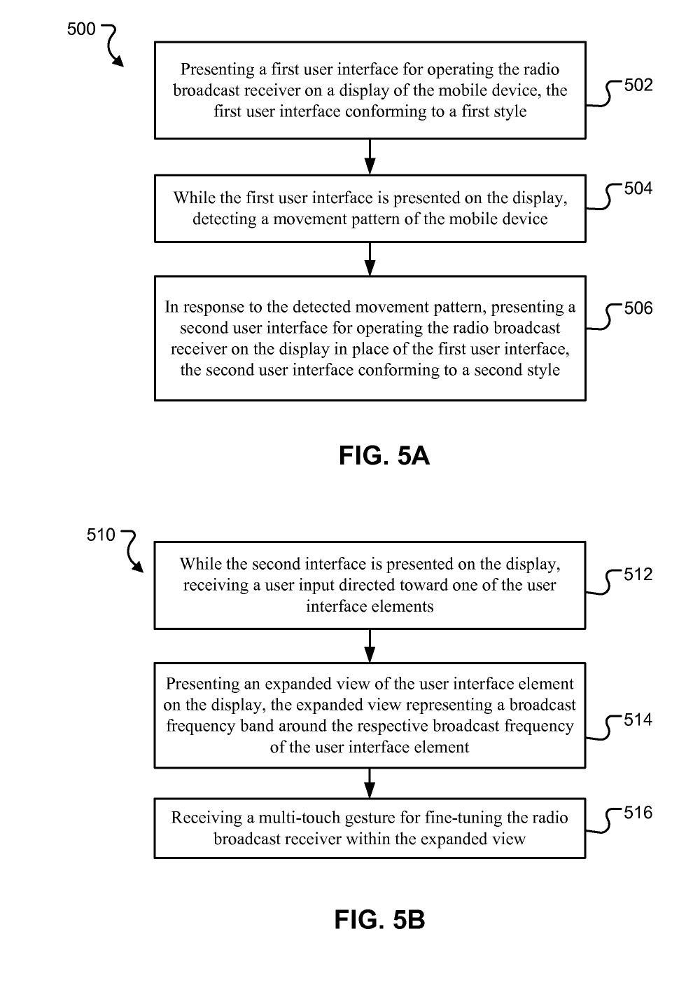

FIG. 5 is a flow diagram of an example process 500 for switching between a first user interface and a second user interface for the radio broadcast receiver on a mobile device. When the radio broadcast receiver is activated, for example, by a user pressing the radio icon 152 on the user interface 106 in FIG. 1, a first user interface for operating the radio broadcast receiver is presented on the display of the mobile device (502). As described with respect to FIG. 3A, the first user interface conforms to a first style. While the first user interface is presented on the display, a movement pattern of the mobile device is detected (504). In some implementation, the movement pattern can be detected by a motion sensor (e.g., an accelerometer) in the mobile device. In response to the detected movement pattern, a second user interface for operating the radio broadcast receiver is presented on the display in place of the first user interface (506). As discussed with respect to FIG. 3B, the second user interface conforms to a second style. In some implementations, the detected movement pattern can be a rotation of the mobile device from a first orientation to a second orientation. In some implementations, the detected movement pattern can be a rotation of the mobile device from a landscape orientation to a portrait orientation. In some implementations, the transition from the first user interface and the second user interface can include an animated sequence. In some implementations, the display is operable to receive touch or multi-touch gestures, and the first user interface and the second user interface are responsive to different touch or multi-touch gestures for at least one control function of the radio broadcast receiver. For example, for tuning to an adjacent radio station, the first user interface can be responsive to a single touch on a user interface element that indicates a tuning direction and the second user interface can be responsive to a single flick across the display in the tuning direction.

FIG. 5B illustrates an example process for invoking a fine-tuning user interface from the second user interface. For example, as discussed with respect to FIGS. 3A-3B, the display is operable to receive touch and/or multi-touch gestures and the second user interface includes user interface elements each representing a respective broadcast frequency of a corresponding radio station. While the second interface is presented on the display, a user input directed toward one of the user interface elements is received (512). In response to the user input, an expanded view of the user interface element is presented on the display (514). The expanded view represents a broadcast frequency band around the respective broadcast frequency of the user interface element. For example, the user interface element is a vertical bar representing a detected and/or currently selected broadcast frequency. The expanded view of the user interface element can be an expanded vertical bar representing a narrow frequency range around the detected and/or currently selected broadcast frequency. Alternatively, the expanded view can be a window presenting the entire narrow frequency range around the detected and/or currently selected broadcast frequency. When the expanded view of the user interface element is presented, a multi-touch gesture for fine-tuning the radio broadcast receiver is received within the expanded view (516). The radio broadcast receiver can be fine-tuned within the narrow frequency range.

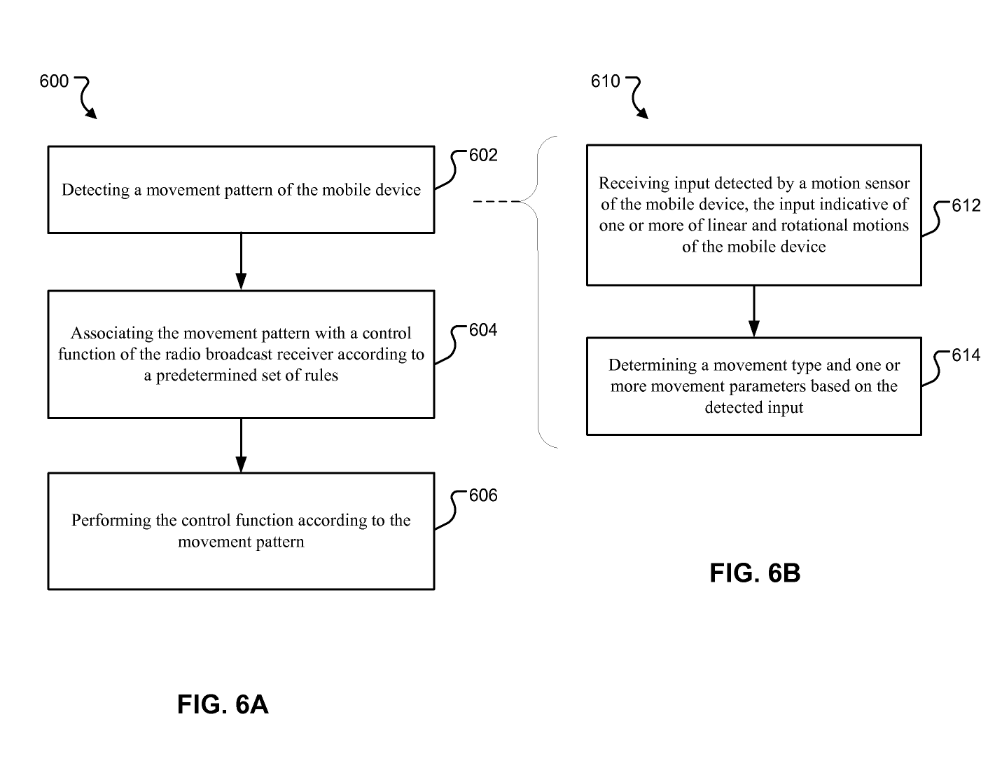

FIGS. 6A-8 show an example processes for controlling a radio broadcast receiver of a mobile device based on movement patterns detected by a motion sensor (e.g., an accelerometer) in the mobile device. In some implementations, a user can control a radio broadcast receiver by shaking or tapping on the mobile device. The user does not have to carefully and meticulously manipulate user interface elements laid out on a graphical user interface using his/her fingertips to achieve a desired radio function. Since no precise manipulation of the graphical user interface elements is required, a user can control the radio receiver while keeping his/her attention focused on some other tasks, such as driving, jogging, and so on. Direct physical movement of the mobile device itself provides a more direct and intuitive way to control the radio broadcast receiver.

In some implementations, movements of the mobile device are detected by a motion sensor in the mobile device and interpreted according to a set of context-based rules. The context information can be provided by previous user inputs, other sensors in the mobile device, or the current state of the radio broadcast receiver. By using a wide variety of context information, only a few simple and intuitive movement patterns are required to operate the radio broadcast receiver, and the interpretation of each movement pattern becomes more accurate given the context of the movement.

As illustrate in FIG. 6A, if the motion sensor-based control is enabled, a movement pattern of the mobile device is first detected (602). The movement pattern is associated with a control function of the radio broadcast receiver according to a predetermined set of rules (604). In some implementations, the predetermined set of rules can include the rules for mapping a movement pattern to a particular control function of the radio broadcast receiver. In some implementations, the rules can also include conditions for ignoring a particular movement pattern as unintentional or accidental movement rather than controlled user input intended for invoking a particular control function. Once the movement pattern is associated with a control function of the radio broadcast device, the control function is performed according to the movement pattern (606). In some implementations, parameters of the movement pattern, such as speed, acceleration, and direction, can be used to modify how a control function is subsequently performed.

As shown in FIG. 6B, in some implementations, input detected by a motion sensor of the mobile device is received (612). The input can be indicative of linear and/or rotational motions of the mobile device. A movement type and one or more movement parameters can be determined based on the detected input (614). In some implementations, the detected movement pattern can be the user shaking the mobile device randomly, rhythmically, in a particular direction, and/or while holding the mobile device in a particular orientation. In some implementations, the movement pattern can be a controlled and deliberate impact (as opposed to an accidental crash) of the mobile device against another object, such as a user's hand. The motion sensor is capable of detecting the onset of the movement, and recording the change of the movement direction and speed for a period of time. The recorded movement is analyzed (e.g., compared to a set of sample movement patterns), and a movement pattern can be identified. In some implementations, a user can record customized sample movement patterns beforehand for comparison. In some implementations, a set of standard sample movement patterns can be specified.

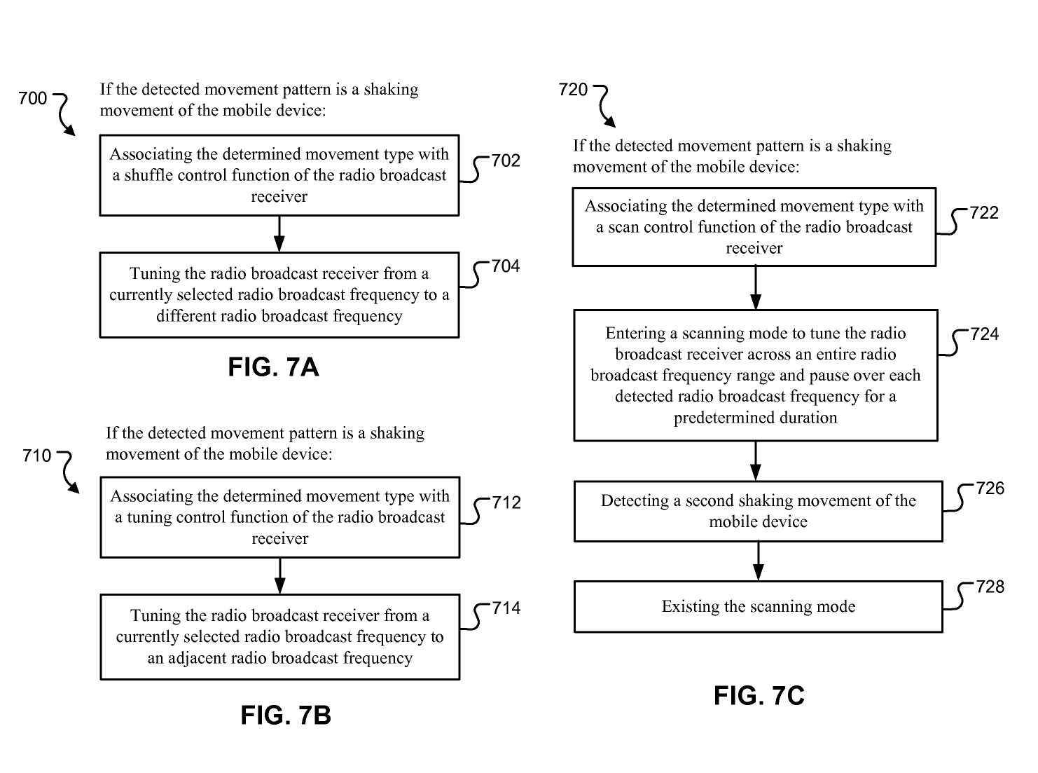

FIGS. 7A-7C show a number of example processes 700, 710, and 720 for mapping a shaking movement of the mobile device to a control function and performing the control function according to the movement pattern.

In one example, as shown in FIG. 7A, the determined movement type is associated with a shuffle control function of the radio broadcast receiver (702). In some implementations, this association between a shaking movement and a shuffle control function is enabled only if the shaking movement follows a random shaking pattern, for example. In response to the shaking movement, the radio broadcast receiver is tuned from a currently selected radio broadcast frequency to a different radio broadcast frequency (704). In some implementations, the currently selected radio broadcast frequency is for a first radio station of a first genre; and the different radio broadcast frequency is for a second radio station of a second, different genre. In some implementations, the currently selected radio broadcast frequency and the different radio broadcast frequency are for radio stations of the same genre. In some implementations, the second radio station is randomly selected from a set of detected radio stations. In some implementations, the second station is randomly selected from a set of detected radio stations of a particular genre (e.g., same genre as the initially selected radio station, or different genre as the initially selected radio station). In some implementations, the second radio station is randomly selected from a set of preset stations. In some implementations, the second radio station is randomly selected from a set of preset stations of a particular genre (e.g., same genre as the initially selected radio station, or different genre as the initially selected radio station).

In another example, as shown in FIG. 7B, the determined movement pattern is associated with a tuning control function of a radio broadcast receiver (712). In some implementations, this mapping between the movement pattern and the tuning control function is enabled only if the shaking is a single shake, for example. If the association is enabled, the radio broadcast receiver is tuned from a currently selected radio broadcast frequency to an adjacent radio broadcast frequency (714). In some implementation, the direction of the shake can be used to determine whether to tune up or down for the adjacent radio broadcast frequency. In some implementations, the radio broadcast receiver is tuned to an adjacent radio frequency that has the strongest detected signal strength. In some implementations, the adjacent radio broadcast frequency is selected from the entire radio broadcast frequency range. In some implementations, the adjacent radio broadcast frequency is selected from a set of preset radio broadcast frequencies.

In another example, as shown in FIG. 7C, the determined movement pattern is associated with a scan control function of a radio broadcast receiver (722). In some implementations, this mapping between the movement pattern and the scan control function is enabled if the shaking is a repeated rhythmic shaking movement, for example. If the association is enabled, the radio broadcast receiver enters a scanning mode to tune the radio broadcast receiver across the entire radio broadcast frequency range and to pause over each detected broadcast frequency for a predetermined duration (724). In some implementations, a second shaking movement of the mobile device for stopping the scanning mode can be detected while the radio broadcast receiver is paused over a particular broadcast frequency (726). In some implementations, other movement or signal from the user can be used to stop the scanning mode. When the stop signal is detected, the radio broadcast receiver can exit the scanning mode (728). In some implementations, the radio broadcast frequency at which the radio broadcast receiver had paused right before existing the scanning mode becomes the selected radio broadcast frequency.

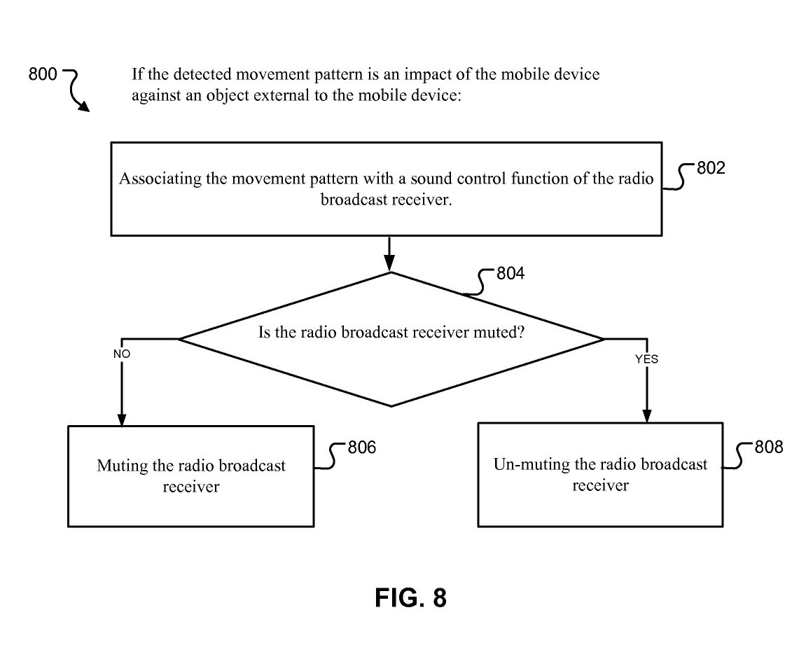

FIG. 8 shows an example processes 800 for mapping a tapping or impact of the mobile device to a sound control function of the radio broadcast receiver and performing the control function according to the movement pattern.

In one example, as shown in FIG. 8, the movement pattern is associated with a sound control function of the radio broadcast receiver (802). Then, it is determined whether the radio broadcast receiver is currently in a muted state (804). Then, the radio broadcast receiver is muted if the radio broadcast receiver was previously un-muted (806). The radio broadcast receiver is un-muted if the radio broadcast receiver was previously muted (808). In some implementations, the association between the tapping/impact and the sound control function is only enabled if the ambient light sensor detects that the ambient light is dim (e.g., when the mobile device is inside a user's pocket). In some implementations, other associations between a tapping movement and sound control functions are possible. For example, a double tap can be associated with decreasing volume, while a triple tap can be associated with increasing volume. In some implementations, a user can customize the association between different tapping patterns and different control functions of the radio broadcast receiver.

The examples are illustrative of how a movement pattern can be associated with a control function of a radio broadcast receiver. The examples further illustrate how other information, such as user's previous inputs, inputs from other sensors, and the current state of the broadcast receiver can be used to provide context of the movement patterns, and to more accurately interpret the purposes of the movement patterns. Other rules and movement patterns can be implemented. A user can also customize the rules and movement patterns. For example, tapping with different rhythmic patterns or different number of taps can be mapped to different control functions. Other rules for detecting and filtering out accidental or unintentional movements of the mobile device can also be implemented.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method for controlling a radio broadcast receiver on a mobile device, comprising:
presenting a first user interface for operating the radio broadcast receiver on a display of the mobile device, the first user interface conforming to a first style;
while the first user interface is presented on the display, detecting a movement pattern of the mobile device; and
in response to the detected movement pattern, presenting a second user interface for operating the radio broadcast receiver on the display in place of the first user interface, the second user interface conforming to a second style.

2. The method of claim 1, wherein the detected movement pattern comprises a rotation of the mobile device from a first orientation to a second orientation.

3. The method of claim 1, wherein the display is operative to receive multi-touch gestures, the first user interface is responsive to a first multi-touch gesture for a particular control function of the radio broadcast receiver, and the second user interface is responsive to a second, different multi-touch gesture for the particular control function.

4. The method of claim 3, wherein, for tuning to an adjacent radio station, the first multi-touch gesture is a single touch on a user interface element that indicates a tuning direction, and the second, different multi-touch gesture is a single flick across the display in the tuning direction.

5. The method of claim 1, wherein the display is operable to receive multi-touch gestures and the second user interface includes user interface elements each representing a respective radio broadcast frequency of a corresponding radio station, the method further comprising:
while the second interface is presented on the display, receiving a user input directed toward one of the user interface elements;
presenting an expanded view of the user interface element on the display, the expanded view representing a broadcast frequency band around the respective broadcast frequency of the user interface element; and
receiving a multi-touch gesture for fine-tuning the radio broadcast receiver within the expanded view.

6. A computer-implemented method for controlling a radio broadcast receiver on a mobile device, comprising:
detecting a movement pattern of the mobile device;
associating the movement pattern with a control function of the radio broadcast receiver according to a predetermined set of rules; and
performing the control function according to the movement pattern.

7. The method of claim 6, wherein detecting the movement pattern further comprises:
receiving input detected by a motion sensor of the mobile device, the input indicative of one or more of linear and rotational motions of the mobile device;
determining a movement type and one or more movement parameters based on the detected input.

8. The method of claim 7, wherein the determined movement type is a shaking movement of the mobile device.

9. The method of claim 8, wherein associating the movement pattern with a control function of the radio broadcast receiver further comprises:
associating the determined movement type with a shuffle control function of the radio broadcast receiver.

10. The method of claim 9, wherein performing the control function according to the movement pattern further comprises:
tuning the radio broadcast receiver from a currently selected radio broadcast frequency to a different radio broadcast frequency.

11. The method of claim 10, wherein the currently selected radio broadcast frequency is for a first radio station of a first genre, and the different radio broadcast frequency is for a second radio station of a second, different genre.

12. The method of claim 10, wherein the currently selected radio broadcast frequency and the different radio broadcast frequency are for radio stations of a same genre.

13. The method of claim 10, wherein the different radio broadcast frequency is selected from a set of preset frequencies.

14. The method of claim 7, wherein the determined movement type is an impact of the mobile device against an object external to the mobile device.

15. The method of claim 14, wherein associating the movement pattern with a control function of the radio broadcast receiver further comprises:
associating the movement pattern with a sound control function of the radio broadcast receiver.

16. The method of claim 15, wherein performing the control function according to the movement pattern further comprises:
muting the radio broadcast receiver if the radio broadcast receiver was un-muted prior to detection of the movement pattern.

17. The method of claim 15, wherein performing the control function according to the movement pattern further comprises:
un-muting the radio broadcast receiver if the radio broadcast receiver was muted prior to detection of the movement pattern.

18. A computer-implemented method for controlling a radio broadcast receiver on a mobile device, comprising:
detecting a shaking movement of the mobile device;
associating the shaking movement with a shuffle function of the radio broadcast receiver; and
changing a currently selected broadcast frequency of the radio broadcast receiver to a different broadcast frequency according to a random selection procedure.

19. A computer program product, encoded on a tangible program carrier, operable to cause a portable device to perform operations comprising:
presenting a first user interface for operating the radio broadcast receiver on a display of the mobile device, the first user interface conforming to a first style;
while the first user interface is presented on the display, detecting a movement pattern of the mobile device; and
in response to the detected movement pattern, presenting a second user interface for operating the radio broadcast receiver on the display in place of the first user interface, the second user interface conforming to a second style.

20. A portable device comprising:
a touch-sensitive display;
memory;
one or more processors; and
instructions stored in the memory and configured for execution by the one or more processors, the instructions comprising instructions to:
presenting a first user interface for operating the radio broadcast receiver on a display of the mobile device, the first user interface conforming to a first style;
while the first user interface is presented on the display, detecting a movement pattern of the mobile device; and
in response to the detected movement pattern, presenting a second user interface for operating the radio broadcast receiver on the display in place of the first user interface, the second user interface conforming to a second style.
